(19) United States
(12) Patent Application Publication
(10) Pub. No.: US 2012/0062197 A1
(43) Pub. Date: Mar. 15, 2012

(54) ELECTRONIC DEVICE AND METHOD FOR DISCRETE LOAD ADAPTIVE VOLTAGE REGULATION

(76) Inventors: Michael Lüders, Munchen (DE); Ralf Brederlow, Poing (DE); Rüdiger Kuhn, Freising (DE)

(21) Appl. No.: 13/180,367

(22) Filed: Jul. 11, 2011

(30) Foreign Application Priority Data
Sep. 10, 2010 (DE) DE 102010044924.5

(51) Int. Cl. G05F 1/10

(52) U.S. Cl. 323/282

(57) ABSTRACT

The invention relates to an electronic device which comprises a voltage regulator for providing a regulated output voltage to an electronic circuit and a control stage coupled to control the voltage regulator. The control stage is further configured to detect a request for a change of a system configuration of the electronic circuit coupled to receive the output voltage of the voltage regulator, to determine an activity factor of the electronic circuit for the requested system configuration, to determine a system clock frequency of a system clock of the electronic circuit, to determine a required current drive level of the voltage regulator based on the activity factor, the system clock frequency or the product of both, and to adjust the current drive level of the voltage regulator to the requested current drive level.

### FIELD OF THE INVENTION

The invention relates to an electronic device and a method for load adaptive voltage regulation.

### BACKGROUND

Voltage regulators are often based on analog control loops which monitor and control the output voltage of the voltage regulator in order to keep the output voltage within a small window around a target output voltage level. A voltage regulator may be either a linear voltage regulator or a switched voltage regulator.

FIG. 1 shows a simplified circuit and block diagram of a voltage regulator 1 used in accordance with the prior art. The voltage regulator receives a reference voltage VR and provides an output voltage VO for supplying a load. The load is represented by a current source IL sourcing a load current from the output voltage note VO. There is also a buffer capacitance CB. The buffer capacitance holds a certain amount of charge for buffering rather short current peaks of the load current. The larger the capacitance value of the buffer capacitance CB, the slower the voltage regulator 1 can adapted to variations in the load current, i.e. a slow transient response of the voltage regulator is possible, if a large capacitor CB is used.

FIG. 2 shows a simplified block and circuit diagram of a linear voltage regulator. The linear voltage regulator 1 mainly includes an operational (or error) amplifier OP1 and a pass-device M1. The pass-device M1 is typically a MOSFET transistor, the channel of which is coupled between the output node VO and the supply voltage VDD. The pass-device M1 and the operational amplifier OP1 form a feedback loop. The operational amplifier OP1 senses the output voltage VO for comparing it with a reference voltage VR and generates an error signal that modulates the pass-device M1 in order to keep the output voltage level VO constant. The two main challenges of designing linear voltage regulators are loop stability and transient response.

In order to ensure loop stability, the feedback loop of a linear voltage regulator requires some kind of compensation. Independent of the value of the load capacitance CB, loop stability may be achieved using a concept which is referred to as any-load stable LDO architecture, which is known from U.S. Pat. No. 6,930,551 B2 and the publication “Design Methodology and Circuit Techniques for Any-Load Stable LDOs with Instant Load Regulation and Low Noise”, 2008 of Vadim Ivanov. However, the loop stability is achieved by either an increased quiescent current or a larger load capacitance CL.

Another characteristic of a linear voltage regulator is its transient response. The transient response defines the amount of time needed for adjusting the output voltage VO after a change of the load current IL. The output voltage variation in response to a worst-case change in load current IL is determined by the response time of the control loop, a specified maximum load current and the value of the load capacitance. Therefore, a smaller output voltage variation may either be achieved by a faster control loop, which requires an increased quiescent current or a larger load capacitance.

From the previous considerations, it can be derived that the buffer capacitance, in particular the value of the buffer capacitance, is essential for the stability of the control loop of a voltage regulator. The buffer capacitance is necessary for compensating slow reaction of the feedback loop. Therefore, the design of linear regulators becomes more challenging when the value of the buffer capacitance is reduced. However, this is typically the case in fully integrated linear voltage regulators which have only small on-chip buffer capacitance values.

The same considerations apply for switched voltage regulators. Switching voltage regulators rapidly switch the pass-device on and off. The duty cycle of the switch defines the amount of charge which is transferred to the load. The switching and the amount of charge are controlled by a similar feedback mechanism as known from the linear voltage regulators.

A voltage regulator consumes a certain amount of quiescent current. This quiescent current tends to dominate the overall system current consumption in low load conditions. This is particularly relevant for systems-on-chip, which typically offer various operating modes. There is for example an active mode in which all sub-circuits are active. Furthermore, there are various low power modes down to data retention mode in which operation of all sub-circuits is stopped. On the other hand, a voltage regulator should not be faster than necessary in order to keep its power consumption low while keeping the output voltage level within a given target window. Therefore, current systems-on-chip contain multiple voltage regulators, each of which is optimized for a specific operating mode. The major disadvantages of the prior art solutions are the complex switching schemes required to switch from one operating mode to another, the relatively long time required for switching from one operating mode to another and the additional chip-area required for each additional voltage regulator.

According to another conventional solution, the current driving capability of the voltage regulator can be scaled down. This is performed by decreasing the quiescent current of a single voltage regulator as a function of the load current. Prior art concepts using this approach are known from Yat-Hei Lam and Wing-Hung Ki, “A 0.9V 0.35 μm Adaptively Biased CMOS LDO Regulator with Fast Transient Response”, IEEE International Solid State Circuits Conference, (ISSCC) pp. 442-443 & 626, February 2008 and Yat-Hei Lam, Wing-Hung Ki and Chi-Jing Tsui, “Adaptively-Biased Capacitor-Less CMOS Low Dropout Regulator with Direct Current Feedback”, Special Feature Award, University LSI Design Contest, IEEE/ACM 11^{th} Asia and South Pacific Design Automation Conference (ASP-DAC), Yokohama, Japan, pp. 104-105, January 2006.

However, the solutions disclosed in the previously mentioned publications have the disadvantages that any adaption of the quiescent current has to react on all load changes which introduces significant delay and slows down the control mechanism. Furthermore, there are two independent control loops which increases the quiescent current and the quiescent current only scales slightly with the load current.

### SUMMARY

It is an object of the invention to provide a voltage regulator having a lower current consumption and a faster transient response than the solutions according to the prior art for the same buffer capacitance.

According to an aspect of the invention, an electronic device is provided, which comprises a voltage regulator for providing a regulated output voltage to an electronic circuit. The electronic device also comprises a control stage coupled to control the voltage regulator. The control stage is configured to detect a request for a change of a system configuration of the electronic circuit. The electronic circuit is coupled to receive the output voltage of the voltage regulator. The control stage may further be configured to determine an activity factor of the electronic circuit for the requested system configuration. Alternatively or in addition to the activity factor, the electronic device may be configured to determine a system clock frequency of the system clock of the electronic circuit. If the system clock frequency and the activity factor are used, the control stage can be configured to multiply the activity factor with the system clock frequency. The control stage can be configured to determine a required current drive level of the voltage regulator based on the system clock frequency, the activity factor, or the product of the activity factor and the system clock frequency and to adjust the current drive level of the voltage regulator to the requested current drive level. In an advantageous aspect of the invention, the electronic device may be configured to adjust the current drive level of the voltage regulator in multiple discrete steps in response to an activity factor and/or a clock frequency of the electronic circuit, which is to be supplied by the voltage regulator. The solution according to these aspects of the invention may also be referred to as “digitally enhanced control loop”.

Accordingly, a new approach to load adaptive voltage regulation is presented. The solution according to the present invention uses a precise knowledge of the system in order to support the control loop of a voltage regulator. Conventional voltage regulators are based on the problem that the load of a voltage regulator is unknown. Therefore, a voltage regulator according to the prior art has to be designed for the absolute maximum value of a load current. Furthermore, the present invention is based on the cognition that some electronic circuits allow the load current to be predicted. If the electronic circuit, which is supplied by the voltage regulator, is for example a digital CMOS-circuit, certain assumptions with respect to the required load current can be made. The current consumption of a digital CMOS-circuit basically consists of two components. One is the dynamic current due to charging and discharging of the logic gates and the other is the leakage current due to various non-ideal effects, where sub-threshold currents are dominating. If the digital CMOS circuit is activated, the overall current dissipation is dominated by the dynamic currents. The dynamic currents linearly depend on the switching activity factor (also referred to as transition probability) as well as the system clock frequency. Therefore, the overall current consumption can be predicted and a current drive level for the voltage regulator can be determined in response to the system clock and/or the activity factor.

In an aspect of the invention, the voltage regulator may be configured to have an adjustable quiescent current for adjusting the current drive level. Typically, the current drive capability of a voltage regulator depends on the quiescent current through internal components (typically transistors) of the voltage regulator. This can be used to reduce the quiescent current. Based on the knowledge of the system clock and/or the activity factor, the current drive level can be reduced.

According to another aspect of the invention, the voltage regulator may be configured to comprise transistors having an adjustable channel width to be adjusted in response to a change of the current drive level of the voltage regulator. This aspect of the invention provides that the drive capability of the voltage regulator can be further adjusted in response to a change of the activity factor and/or the system clock. Accordingly, not only the quiescent current is adjusted but also the channel width, i.e. the physical properties of the transistors of the voltage regulator.

According to an aspect of the invention, the electronic circuit may advantageously be a digital CMOS circuitry.

The activity factor may be determined using a look-up table stored in the electronic device. For a specific configuration of the circuit, the activity factor may then be taken from the look-up table. The required current drive capability for a specific activity factor and a clock frequency may be predetermined and stored in the electronic device. This provides that the transient response of the voltage regulator according to the invention can be much faster than the transient response of voltage regulators according to the prior art, even if a comparatively small buffer capacitor is used.

The voltage regulator may advantageously comprise a first voltage regulation stage and a second regulation stage. The first voltage regulation stage may then have a first gain and the second voltage regulation stage may have a second gain. The first gain may be greater than the second gain. Furthermore, the first voltage regulation stage may have a first transient response and the second voltage regulation stage may have a second transient response. The first transient response may then be slower than the second transient response. These characteristics of the two stages provide a very stable and very quick voltage regulation with a comparatively small margin of the output voltage.

The invention also provides a method for regulating an output voltage of a voltage regulator. Accordingly, a request for a change of a system configuration of an electronic circuit, which is coupled to receive the output voltage of the voltage regulator, is detected. An activity factor of the electronic circuit for the requested system configuration is determined. A system clock frequency of a system clock of the electronic circuit is determined. This is performed based on the activity factor and/or the system clock frequency. The current drive level of the voltage regulator is then adjusted to the requested current drive level. The activity factor may also be multiplied with the system clock frequency and a required current drive level of the voltage regulator may be determined based on the product.

Further aspects of the invention will ensue from the following description of preferred embodiments of the invention with reference to the accompanying drawings, wherein

### BRIEF DESCRIPTION OF DRAWINGS

FIG. 1 shows a simplified circuit and block diagram of a voltage regulator according to the prior art,

FIG. 2 shows a simplified circuit and block diagram of a linear voltage regulator according to the prior art,

FIG. 3 shows a simplified circuit and block diagram of an electronic circuit including a voltage regulator which supplies a digital CMOS-circuit;

FIG. 4 shows a simplified diagram illustrating the relationship between activity factor, system clock frequency and load current,

FIG. 5 shows a simplified circuit and block diagram of an electronic device according to an embodiment of the invention,

FIG. 6 shows a simplified diagram illustrating the regulation mechanism according to aspects of the invention,

FIG. 7 shows a flow-chart according to an embodiment of the invention,

FIG. 8 shows a simplified circuit diagram of a voltage regulator according to an embodiment of the invention,

FIG. 9 shows a simplified circuit diagram of a voltage regulator according to an embodiment of the invention,

FIG. 10 shows a simplified diagram of a voltage regulator according to an embodiment of the invention.

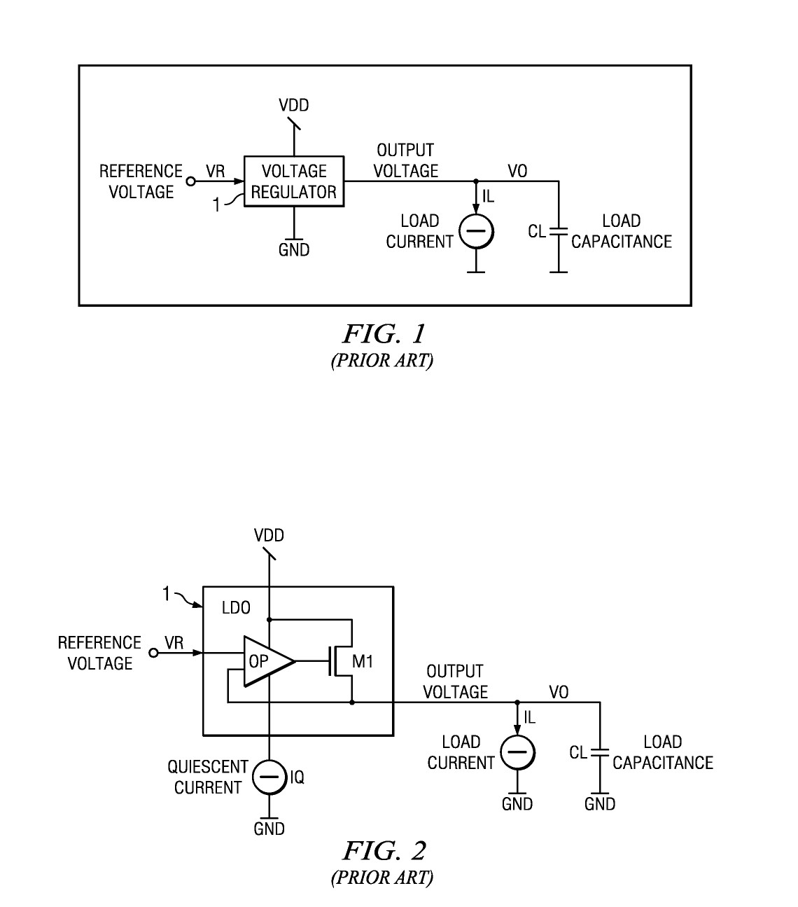

### DETAILED DESCRIPTION OF AN EXAMPLE EMBODIMENTS

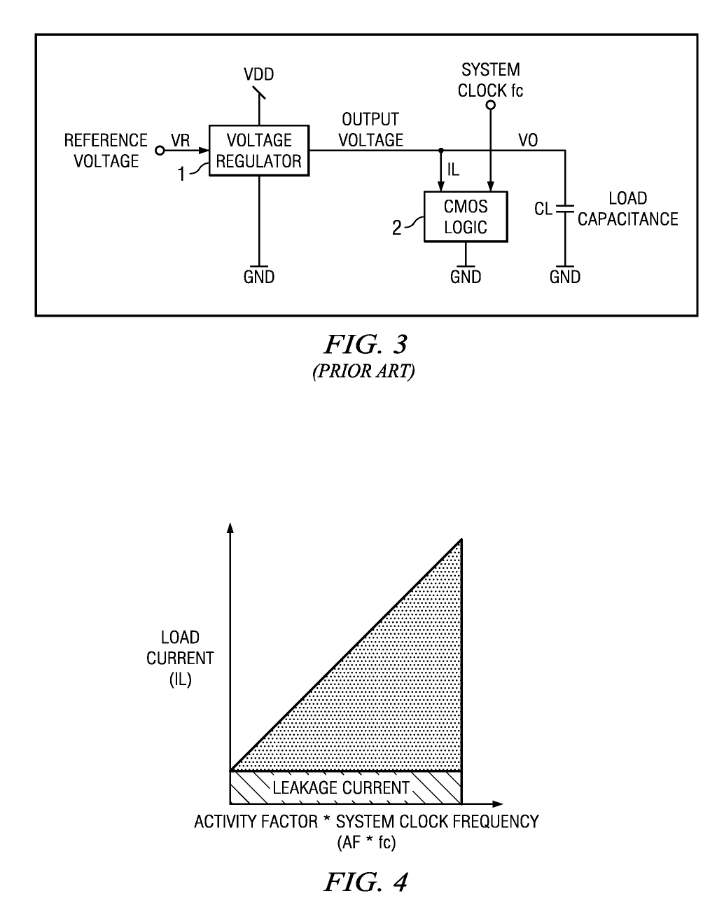

FIG. 3 shows a simplified block and circuit diagram of a voltage regulator 1 coupled for driving an electronic circuit 2. In FIG. 3, the electronic circuit is a digital CMOS-circuit. The CMOS circuit 2 receives a system clock frequency f_{c} and operates in accordance with the system clock frequency f_{c}. Furthermore, the CMOS circuit 2 receives the output voltage VO of the voltage regulator 1 which provides a regulated output voltage VO in response to a reference voltage VR. During operation, the electronic circuit 2 consumes a specific amount of load current IL. Furthermore, there is a buffer capacitance CL, which provides the stability of the voltage regulator 1 as previously described.

FIG. 4 shows a simplified diagram illustrating the relationship between the activity factor AF, the system clock frequency f_{c} and the load current IL. Accordingly, there is a certain amount of leakage current, which is always present and consumed by the digital circuit even if it is not active. Furthermore, with increasing activity factor and/or a system clock frequency, the load current IL linearly increases. This is basically always the case for digital integrated circuits. The load current IL is a function, and more specifically, a linear function of the product of the activity factor and the system clock frequency.

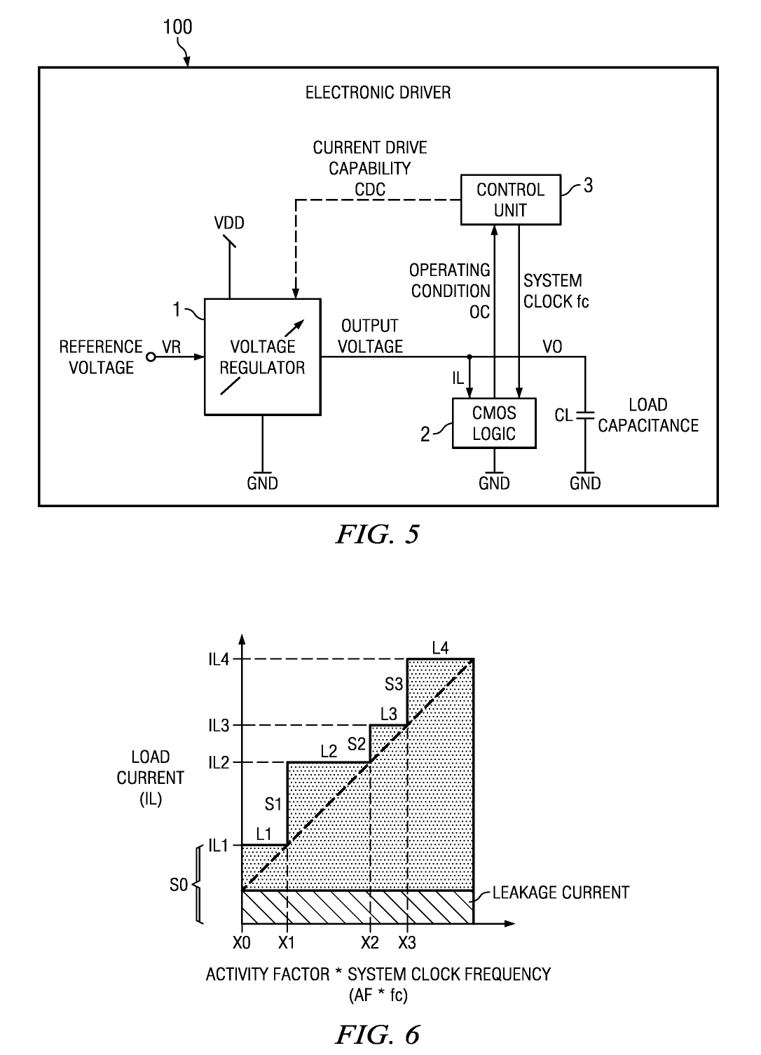

FIG. 5 shows an electronic device 100 which is implemented in accordance with aspects of the invention. There is a voltage regulator 1 receiving a reference voltage VR and providing a regulated output voltage VO. The regulated output voltage VO is used for supplying an electronic circuit 2, which is a digital CMOS logic or a digital CMOS stage. The digital stage is driven with a system clock frequency f_{c}. Therefore, the electronic circuit 2 consumes a certain amount of current IL in accordance with the system clock frequency and the activity factor AF. Furthermore, there is a control unit 3, which is configured in accordance with aspects of the invention. The control unit 3 is coupled to adjust the voltage regulator by a signal referred to as current drive capability signal CDC. Control unit 3 receives operating conditions OC from the CMOS logic and also refers to look-up tables in order to determine activity factors of the electronic circuit 2. In response to the received operating conditions OC and the system clock frequency f_{c}, the parameters of the voltage regulator 1 are adjusted using the current drive capability signal CDC. The control unit 3 is configured to issue the required signals CDC in response to the system conditions (activity factor AF and system clock) of the electronic circuit. Using the control unit 3 according to the invention and the enhanced control mechanism for adjusting the current drive capability of the voltage regulator 1 enables the use of smaller buffer capacitors CB. Furthermore, the buffer capacitor CB may then have capacitance values that render it possible to integrate the buffer capacitor in an integrated circuit.

FIG. 6 shows a simplified diagram illustrating a regulation scheme according to aspects of the invention. In accordance with aspects of the invention, the linear control mechanism is changed in accordance with aspects of the invention. FIG. 6 shows several discrete steps S0, S1, S2 and S3 during which the load current is increased from several discrete levels L1, L2, L3 and L4 from current IL1, IL2, IL3 to current IL4. If the product of the activity factor AF and the system clock frequency f_{c} is greater than X0, a first level L1 having a corresponding magnitude IL1 of the load current IL is assumed. Between X0 and X1, the same magnitude IL1 for the output current IL is maintained. If the product of the activity factor AF and the system clock frequency f_{c} exceeds X1, the output current IL is adjusted by a step S1 so as to assume a level L2 with a magnitude IL2 of the load current IL. Between X1 and X2, this level is maintained until the product of the activity factor AF and the system clock frequency f_{c} exceeds the next threshold level X2. Between X2 and X3 the output current level is IL3. Above X3, the output current drive capability is IL4. Accordingly, the current drive capability of the voltage regulator is controlled in several discrete steps. This provides an improved transient response and a smaller power consumption compared with solutions according to the prior art. Furthermore, smaller buffer capacitors may be used. Although in this embodiment, there are four current drive levels shown, the number and location of levels is very flexible and can be adapted to various system requirements.

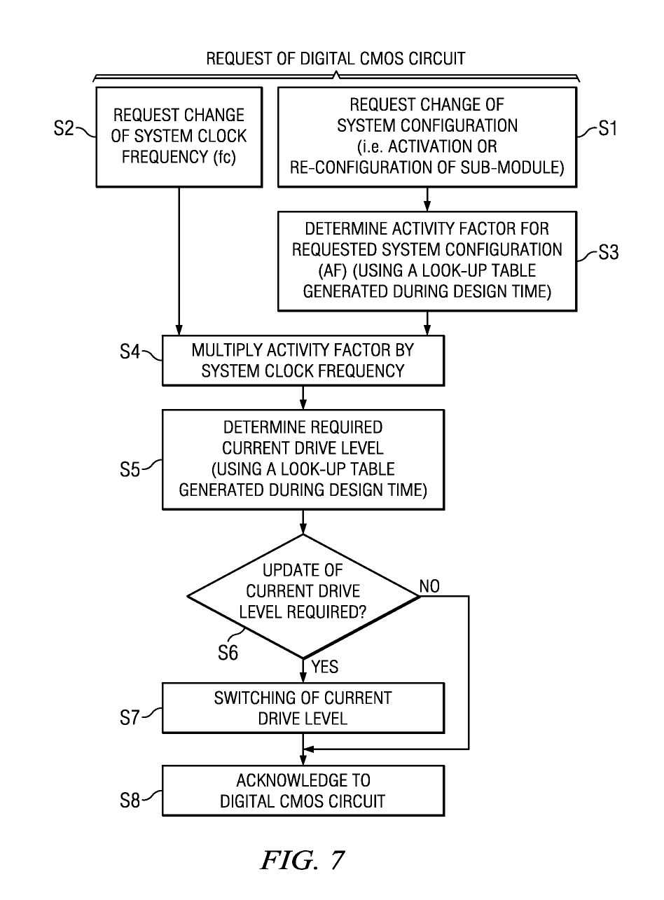

FIG. 7 is a flow chart of a method implemented in accordance with aspects of the invention. In step S1, a change of a system configuration of the electronic circuit (digital CMOS circuit 2) is requested. Change of the system configuration in step S1 may for example be an activation or reconfiguration of a sub-module of the circuit. In step S3 (following step S1), an activity factor AF for the requested system configuration is determined. This may advantageously be performed by using a look-up table stored in the electronic device. The look-up table may be set up during the design of the electronic circuit.

Parallel to the determination of the activity factor AF, a request of a change of a system clock frequency f_{c} may occur. Such a change of the system clock frequency or determination of system clock frequency f_{c} as such is performed in step S2. In step S4, the results of determination of the activity factor AF and the system clock frequency f_{c} are multiplied. The product indicates a specific current drive level to which the voltage regulator should be adjusted. This is performed in step S5. The current drive level may also be determined using a look-up table, which is generated during design time and stored in the electronic device. After step S5, it is decided whether or not an update of the current drive level of the voltage regulator is necessary. This is performed in step S6. If an update of the current drive level is necessary, the current drive capability of the voltage regulator is switched in step S7. If no update of the current drive level is required, the current drive level of the voltage regulator is not changed and either the current drive level change or the fact that no change occurred is acknowledged to the digital CMOS circuit in step S8.

In order to determine the required current drive level for the voltage regulator and to adjust the voltage regulator accordingly, either the system clock frequency or the activity factor may be used individually.

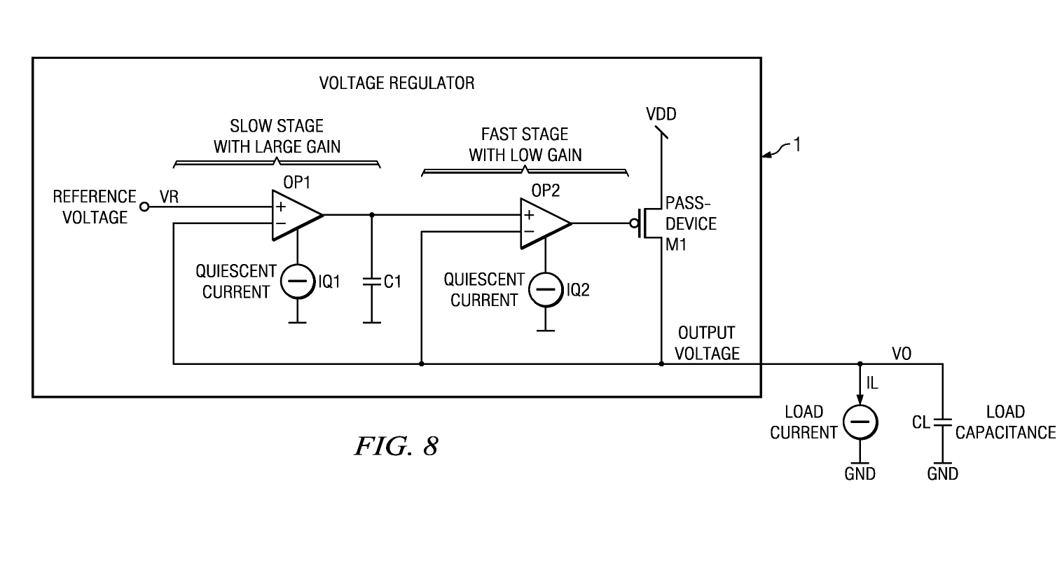

FIG. 8 shows a voltage regulator 1 implemented in accordance with aspects of the present invention. Accordingly, the voltage regulator 1 includes two stages. The first stage includes a first operational amplifier OP1, a quiescent current source IQ1 and a capacitor C1. The second stage includes a second operational amplifier OP2 and a second quiescent current source lQ2. First operational amplifier OP1 receives the reference voltage VR at a positive input. The negative inputs of the operational amplifiers OP1 and OP2 are coupled to receive the output voltage VO. The output of the operational amplifier OP2 is coupled to the pass-device Ml. The pass-device M1 is coupled between supply voltage VDD and output voltage VO. The output of the first operational amplifier OP1 is coupled to the positive input of the operational amplifier OP2. The output voltage is coupled to a load current source IL, representing a load, as for example an electronic circuit 2 (digital CMOS logic). Furthermore, there is a buffer capacitance CB, which is also coupled to receive the output voltage VO. As previously mentioned, this buffer capacitor may now be substantially reduced with respect to its capacitance value, as the transient response of the voltage regulator is much faster than without the control mechanism according to the invention.

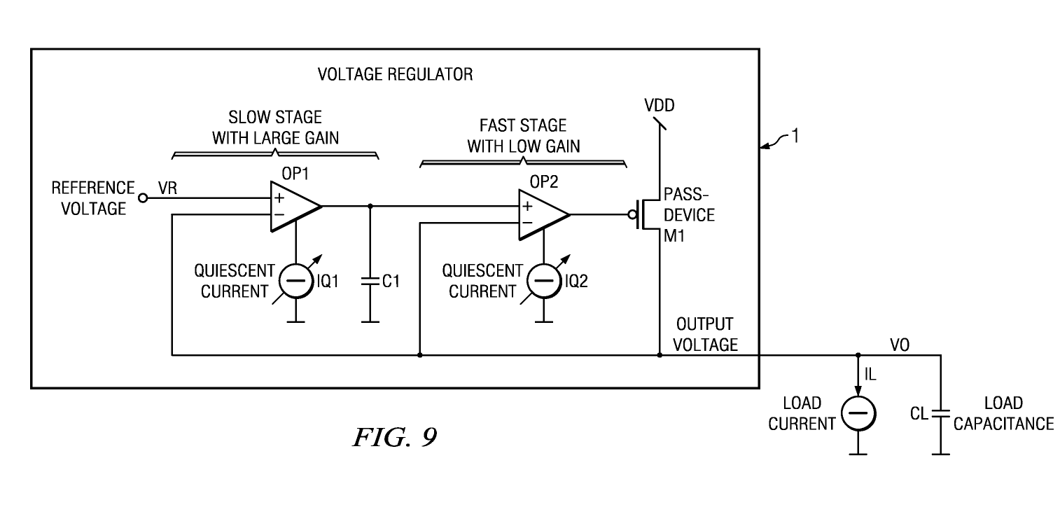

FIG. 9 shows a voltage regulator 1 implemented in accordance with aspects of the invention. The circuit shown in FIG. 9 is basically similar to the circuit shown in FIG. 8. However, the quiescent current sources IQ1 and IQ2 are variable. The quiescent current may now be adjusted in response to the product of the activity factor and the system clock frequency as described with respect to FIG. 7 and in accordance with aspects of the invention. If the activity factor AF and/or the system clock frequency f_{c} decrease, the quiescent current of the operational amplifiers OP1 and OP2 can also be decreased. Signal CDC shown in FIG. 5.

An example of a low-dropout voltage regulator which can be used for present invention is the two stage configuration shown in FIGS. 8 and 9. The quiescent current of both stages is scaled linearly and as a function of the required current drive level and thereby with maximum load current. In an embodiment of the invention, six current drive levels may be defined. In the lowest level L1, the LDO is able to drive, for example, up to 312 μA. While drawing a quiescent current of only 500 nA. The highest current drive level L4, the LDO may be able to drive up to 10 mA of load current with a quiescent current of 16 μA.

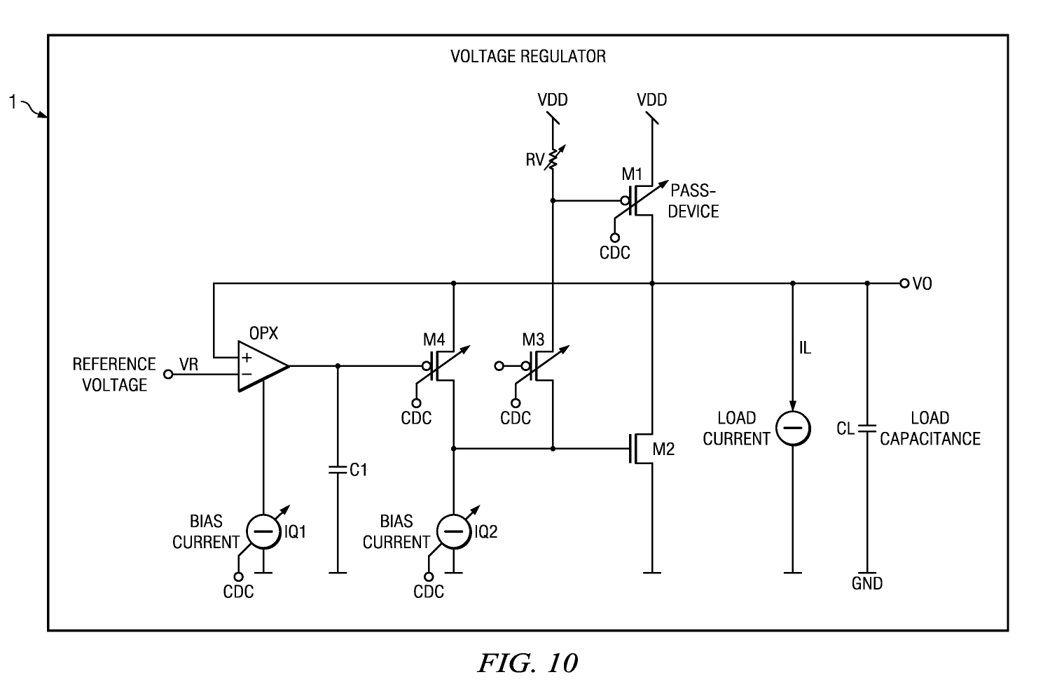

FIG. 10 shows a simplified circuit diagram of a voltage regulator 1 according to another embodiment of the invention. There is an operational amplifier OPX which is coupled with a negative input to the output voltage VO. The positive input of the operational amplifier OPX receives the reference voltage VR. The operational amplifier OPX is biased with a quiescent bias current IQ1. The output port of operational amplifier OPX is coupled to a capacitor C1. Furthermore, the output of operational amplifier OPX is also coupled to a gate of variable transistor M4. The channel of the variable transistor M4 is coupled between the output note VO and another bias current source 1Q2. The bias current sources IQ1 and IQ2 are both variable. The bias currents or quiescent currents provided by the two bias current sources IQ1 and IQ2 are adjusted in response to the product of the activity factor AF and the system clock frequency f_{c} as described with respect to FIG. 7 and other aspects of the invention. Furthermore, there is a variable transistor M3. The gate of M3 is biased by a constant bias voltage level VBIAS. The channel of M3 is coupled between a variable resistor, the gate of the pass-device M1 and the gate of a transistor M2. The gate of transistor M2 is also coupled between the channel of variable transistor M4 and bias current source IQ2. The channel of transistor M2 is coupled between the output voltage node VO and ground. Furthermore, the pass-device M1 is coupled with its channel between the output voltage node VO and supply voltage level VDD. The variable resistor RV is coupled between supply voltage level VDD and the gate of the pass-device M1. Also the pass-device M1 is variable. With respect to transistors M3, M4 and M1, the variable gate width refers to an adjustable width of the channel of the transistors. This can be implemented by several parallel transistors being switched in accordance with a signal received from the control stage shown in FIG. 5. In accordance with FIG. 5, the signal for adjusting the bias currents IQ1, 1Q2 and the width of the channels of transistors M3, M4 and M1 is a signal CDC (current drive capability signal shown in FIG. 5). The electronic circuit 2, which defines the load current IL, is represented by the load current source IL. Furthermore, there is the buffer capacitance CB also coupled to the output note VO.

FIG. 10 shows a LDO according aspects of the invention on transistor-level. The fast stage may be scaled dependent on the current drive level required. Therefore, the width of the associated transistors as well as the resistance of the associated resistors may be scaled. In this embodiment, resistor RV can also be adjusted as well as the variable transistors and the bias current sources IQ1 and IQ2 in response to signals CDC (current drive level signal from control unit 3).

For a system-on-chip, system operating parameters of the digital CMOS as for example switching activity factor AF and clock frequency f_{c} are known. The switching activity factor AF is mainly dependant on the system configuration, i.e. the number of active sub-modules and their configuration. The respective switching activity factor AF for each system configuration can be easily derived during the design of the circuit. The system clock frequency f_{c} is generated within the system-on-chip and is therefore well known to the control unit. Therefore, knowledge of the system operating parameters enables an adaptive setting of the current drive capability of a voltage regulator therefore leads to quiescent current savings in low load conditions. A control unit is added to the system, which sets the current drive capability of the voltage regulator dependent on the system operating conditions.

For practical implementation, a discrete number of current drive levels (L1, L2, L3 . . . ) is defined. The number and location of the levels is generally flexible and can be adapted with respect to the various system requirements. This allows achieving lowest quiescent current in lowest current drive level while providing maximum load current in highest current drive levels.

The digital CMOS circuit 2 may request either change of the system configuration or a change of the system clock f_{c} depending on the application requirements. Based on these requests, the control unit determines the current drive level and if necessary switches the current drive level of the voltage regulator.

According to the present invention, the switching between the current drive levels is fast and unlimited. It is possible to switch from any current drive level L1, L2, L3, L4 to any other current drive level L1 to L4 within less than one clock cycle independent of the current operating condition of the voltage regulator (LDO).

Although the invention has been described hereinabove with reference to specific embodiments, it is not limited to these embodiments and no doubt further alternatives will occur to the skilled person that lie within the scope of the invention as claimed.

What is claimed:

1. An electronic device comprising a voltage regulator for providing a regulated output voltage to an electronic circuit and a control stage coupled to control the voltage regulator, wherein the control stage is further configured to detect a request for a change of a system configuration of the electronic circuit coupled to receive the output voltage of the voltage regulator, to determine an activity factor of the electronic circuit for the requested system configuration and/or to determine a system clock frequency of a system clock of the electronic circuit, to determine a required current drive level of the voltage regulator based on the activity factor, the clock system frequency or the product of the activity factor and the system clock frequency, and to adjust the current drive level of the voltage regulator to the requested current drive level.

2. The electronic device according to claim 1, wherein the control stage is configured to multiply the activity factor with the system clock frequency.

3. The electronic device according to claim 1 being configured to adjust the current drive level of the voltage regulator in multiple discrete steps in response to a requested activity factor and/or a clock frequency of the electronic circuit.

4. The electronic device according to any previous claim, wherein the voltage regulator is configured to comprise transistors having an adjustable channel width to be adjusted in response to a change of the current drive level of the voltage regulator.

5. The electronic device according to any previous claim, wherein the electronic circuit is a digital CMOS circuitry.

6. The electronic device according to any previous claim, wherein the activity factor is determined using a lookup-table stored in the electronic device.

7. The electronic device according to any previous claim, wherein the voltage regulator comprises a first voltage regulation stage and a second regulation stage, wherein the first voltage regulation stage has a first gain and the second voltage regulation stage has a second gain, and the first gain is greater than the second gain.

8. The electronic device according to any previous claim, wherein the first voltage regulation stage has a first transient response and the second voltage regulation stage has a second transient response, and the first transient response is slower than the second transient response.

9. The electronic device according to claim 8, wherein the first voltage regulation stage has a first transient response and the second voltage regulation stage has a second transient response, and the first transient response is slower than the second transient response.

10. A method for regulating an output voltage of a voltage regulator, the method comprising: detecting a request for a change of a system configuration of an electronic circuit coupled to receive the output voltage of the voltage regulator, determining an activity factor of the electronic circuit for the requested system configuration, and/or determining a system clock frequency of a system clock of the electronic circuit, determining a required current drive level of the voltage regulator based on the the activity factor and/or the system clock frequency, and adjusting the current drive level of the voltage regulator to the requested current drive level.
